(19) United States
(12) Patent Application Publication
(10) Pub. No.: US 2026/0215396 A1
(43) Pub. Date: Jul. 30, 2026

(54) A TEAT

(71) Applicant: Stallion Limited, Palmerston (NZ)

(72) Inventor: Rex Allan PIKE, Masterton (NZ)

(21) Appl. No.: 19/142,012

(22) PCT Filed: Dec. 18, 2023
(86) PCT No.: PCT/NZ2023/050149

§ 371 Date: Jun. 20, 2025

(30) Foreign Application Priority Data
Dec. 20, 2022 (NZ) 795832
Jun. 20, 2023 (NZ) 801071

(51) Int. Cl. A01K 9/00

(52) U.S. Cl. CPC A01K 9/005

(57) ABSTRACT

A teat comprising a moulded hollow body (11) which has an inlet portion (14) and an outlet portion (12). A valve receiving element (15) is located with the inlet portion (14). A valve (19) can be installed in a bore (24) of the valve receiving element (15) which opens from the exterior of the teat body (11) into the interior (25) of the teat body (11).

### FIELD

This invention relates to a teat and more particularly a teat for the feeding of animals.

### BACKGROUND

It is known with teats, particularly those for the feeding of animals, to incorporate a valve in the teat. The purpose of the valve is primarily to prevent the back flow of feed from the teat when the feeding animal applies pressure to the teat and permits flow of the feed into the teat when the animal releases pressure on the teat.

A problem with such valves is the fixing of the valve in the flexible moulded body or shell of the teat. Usually a glue or solvent is used to secure the valve into the body but this can give rise to manufacturing complexities especially when the valve is made of a polyurethane and the shell of the teat is made of natural or synthetic rubber. Also if the adhering of the valve in the teat body is not effected correctly this may lead to glue/solvent coming into contact with a part of the valve which will compromise correct operation of the valve. Furthermore inadequate adhering of the valve in the teat body may result in the valve becoming detached from the teat body.

### SUMMARY

An object of the present invention is to provide a teat of a construction that overcomes or at least reduces the above identified drawbacks associated with fitting the valve in the teat body/shell or to at least provide the public with a useful choice.

A further object of the present invention is to provide a method of manufacturing a teat that overcomes or at least reduces the above identified drawbacks associated with fitting the valve in the teat body/shell or to at least provide the public with a useful choice.

The inventive concept which achieves this object broadly resides in a valve receiving element combined with the body of the teat to facilitate the mounting of a valve.

Broadly in one aspect of the invention there is provided a teat comprising a moulded hollow body that has an inlet end and an outlet end, characterized in that a valve receiving element is located with the inlet end of the shell, the valve receiving element including a bore which opens from the exterior of the body into the interior of the body and a valve installed in the bore.

Broadly in a second aspect of the invention there is provided a teat comprising a moulded hollow body that has an inlet end and an outlet end characterized in that a valve receiving element is located with the inlet end of the body, the valve receiving element including a bore which opens from the exterior of the body into the interior of the body and a valve installed in the bore.

In a preferred form of the invention the valve receiving element is in the form of an annular bush.

In one preferred form of the invention the annular bush has one or more projections that engage with the body.

In another preferred form of the invention the annular bush has one or more recesses into which material from which the body is made can engage.

In a preferred form of the invention the valve receiving element is adhered to the inlet of the body.

In a preferred form of the invention the valve receiving element is mounted in an interference fit with the body.

In a preferred form of the invention the valve receiving element is over moulded in the inlet end of the body. In this form of the invention the valve receiving element has one or more projections that are embedded in the teat body.

In a preferred form of the invention the valve receiving element is formed from a hard plastics material.

In a preferred form of the invention the valve receiving element is formed with an internal thread.

In a preferred form of the invention the valve has a complementary thread to that of the valve receiving element whereby the threaded part of the valve can be fitted into the valve receiving element.

Preferably part of the threads of the valve receiving element and valve engage in an interference fit to lock the valve into the valve receiving element.

Preferably in one form of the invention the moulded hollow body is made from a natural or synthetic rubber material

In the preferred form of the invention the valve includes at least a pair of flats for engagement with a tool to enable the valve to be screwed into the valve receiving element.

According to yet a further broad aspect of the invention there is provided a teat comprising a moulded hollow body which has an inlet end and an outlet end characterized in that a valve over moulded in the inlet end of the body.

In one preferred embodiment the valve component includes a substantially tubular body which is formed from a hard plastics material and fitted to an end of the body is a valve element formed from a flexible material.

Preferably the flexible material is silicon.

According to a preferred embodiment the valve element includes a base portion which has an annular wall that terminates in an inwardly directed rim, the annular wall and rim inter engaging with a complementary peripheral recess and peripherally projecting rim of the tubular body to thereby complete the valve component.

In the preferred form the valve element includes a thin walled operative portion that includes an outlet, the operative portion being configured to be reactive to pressure differentials between the tubular body and the interior of the teat body to cause the opening to open and close.

In a preferred form the outlet is a slot opening.

The present invention also provides a method of making an animal feeding teat the method broadly comprising the steps of forming a valve receiving element, moulding a teat body and engaging the valve receiving element in an inlet end of the teat body.

The method further includes the step of installing a valve in the valve receiving element.

In a preferred embodiment of the method the valve receiving element is over moulded in the part of the body which forms the inlet of the body.

In a preferred embodiment of the method the valve receiving element is adhered to the body.

In a preferred embodiment of the method the valve is screwed into the bush.

In a preferred embodiment of the method the valve is adhered in the bush.

### BRIEF DESCRIPTION OF THE DRAWINGS

In the following more detailed description of embodiments of a teat according to the invention and a method by which the teat can be manufactured, reference will be made to the drawings which form part of this specification and in which:

FIG. 1 is a side elevation view of an example of a teat to which the present invention can be applied,

FIG. 2 is a partial sectioned side elevation view of the teat of FIG. 1 incorporating the present invention with the valve receiving element in the form of a bush which, in the drawing, has not been sectioned,

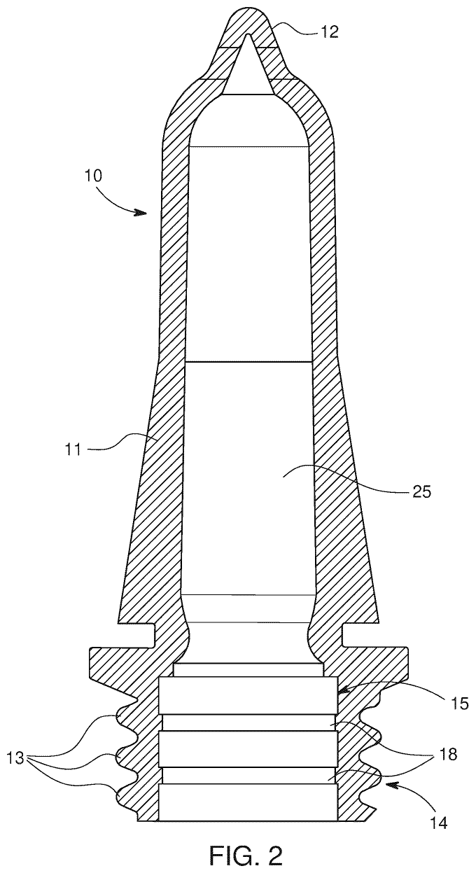

FIG. 3 is a sectioned side elevation view on an enlarged scale of the valve receiving element of FIG. 2,

FIG. 4 is an isometric view on an enlarged scale of the bush shown in FIG. 3,

FIG. 5 is a sectioned side elevation of the teat with the valve receiving element of FIGS. 3 and 4 and a valve component fitted into the valve receiving element,

FIG. 6 is an isometric view (on an enlarged scale) of the valve component shown in FIG. 5,

FIG. 7 is a further isometric view of the valve component as shown in FIG. 6,

FIG. 8 is an isometric view on an enlarged scale of another form of the valve component,

FIG. 9 is an isometric view of the base end of the teat,

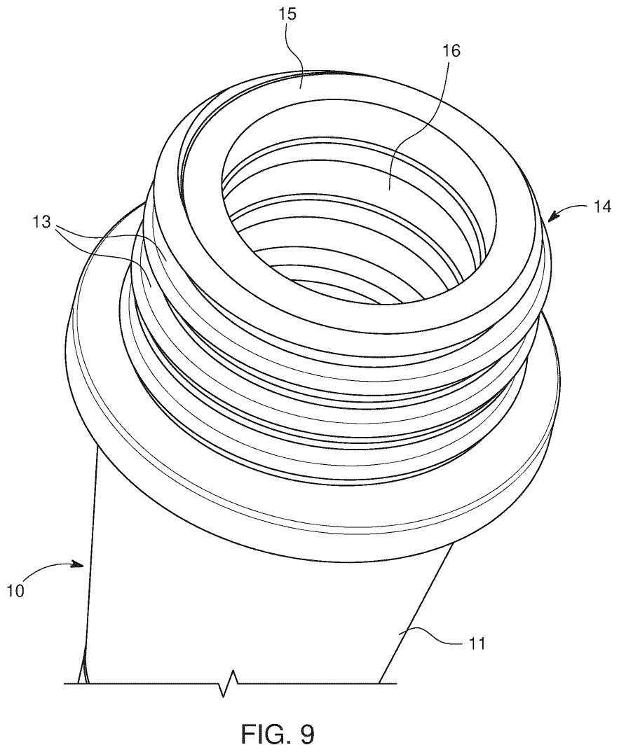

FIG. 10 is an enlarged sectioned side elevation of the inlet end portion of the teat which shows yet a further form of the valve component and fitted into a further embodiment of the valve receiving element,

FIG. 11 is a further sectioned elevation view of the inlet end of the teat fitted with a further form of the valve receiving element, and

FIG. 12 is a sectioned elevation view on an enlarged scale of an even further form of the valve receiving element.

### DETAILED DESCRIPTION OF PREFERRED EMBODIMENTS OF THE INVENTION

The aspects of the present invention will be described herein in relation to one form of an animal feeding teat incorporating the invention. The method by which the teat incorporating the invention can be made will be apparent from the description. It will be appreciated by the skilled addressee that other forms of teat and method can be used.

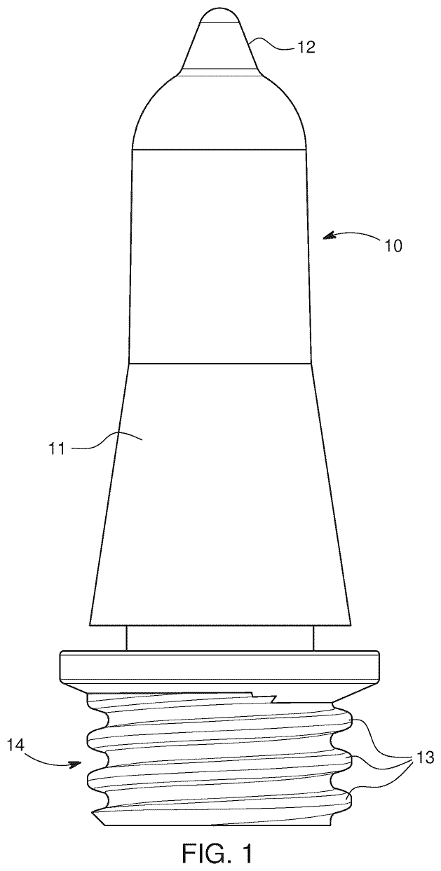

The teat as shown in FIG. 1 of the drawings is a form of animal feeding teat of our company that is commercially marketed under the PEACH registered trade mark. In its preferred form the teat has the distinctive external profile as shown in FIG. 1. This shape of teat is the subject of our New Zealand registered trade mark No. 985827.

The teat 10 includes a hollow shell or body 11 which is moulded from an appropriate material such as a natural or synthetic rubber material. The shell 11 has a nipple or outlet end 12 and a base or inlet end 14. In the illustrated, and one preferred form of the shell 11, the inlet end 14 includes an external thread 13 so that the teat 10 can be screw mounted in an appropriately threaded mounting of, for example, a feeding bottle, bucket or a multi teat feeder.

The profile of the inlet end 14 also enables the teat 10 to be mounted in a circular aperture in accordance with the well known “pull through” type mounting of teats.

According to one form of the invention the valve receiving element 15 is in the form of an annular bush which in the completed teat 10 is mounted with the inlet end 14 of the shell 11. In a preferred form of the teat the inlet end 14 of the shell 11 is formed with a cavity that is suitably configured to receive the valve receiving element 15. The cavity communicates with the hollow interior 25 of the body 11. The bush 15, which can have a substantially smooth external surface, is dimensioned to be a snug fit in the cavity and adhered in the cavity by use of a suitable glue or solvent.

Adhering the bush 15 in the cavity is completed prior to a valve component 19 being fitted to the bush therefore glue/solvent is unlikely to come into contact with the valve component and in particular operative elements of the valve.

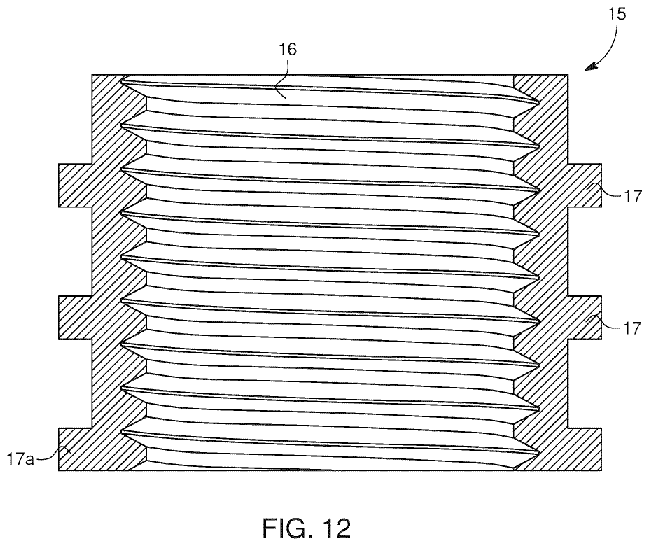

The valve receiving element 15 can have one or a series of projections 17 extending out from the external wall surface thereof as shown in FIG. 12. In this form of the valve receiving element 15 there are a plurality of projections 17, each projection being in the form of a flange extending substantially radially and continuously around the periphery of the bush 15. In the illustrated form of the bush there are three projections 17 with one of the projections 17a situated at or near one end of the bush.

In an alternative embodiment of the bush 15 the projection 17a can extend continuously about the periphery of the bush 15 as shown while the other projections 17 can be discontinuous thereby providing a plurality of separate projections spaced apart around the periphery of the bush.

This form of the bush 15 can be over moulded in the cavity of the inlet end 14 with the projections 17/17a providing anchorage of the bush in the material from which the shell1 is moulded. Alternatively, the cavity in the inlet end can be formed with recesses into which the projections 17/17a engage when the bush 15 is forced into the cavity. In this arrangement the bush is adhered into the cavity by way of suitable glue/solvent.

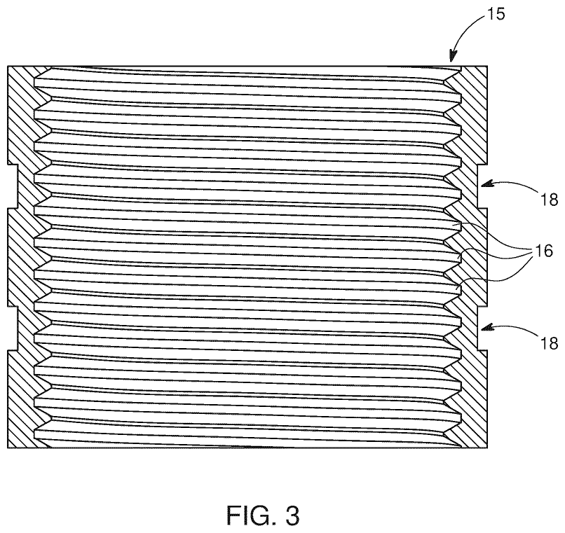

In the embodiment of the valve receiving element 15 shown in FIGS. 3, 4 and 5 the external surface of the bush 15 has one or more (in the illustrated form two) circumferential recesses 18. When over moulded in the teat shell 11 the material from which the shell is moulded fills the recesses 23 to ensure that the bush 15 is held in the cavity in the inlet end 14 of the body 11. Alternatively, the cavity in the inlet end can be moulded with projecting areas that engage in the recesses 18 when the bush 15 is forced into the cavity. In this arrangement the bush 15 is once again adhered by use of glue/solvent into the cavity.

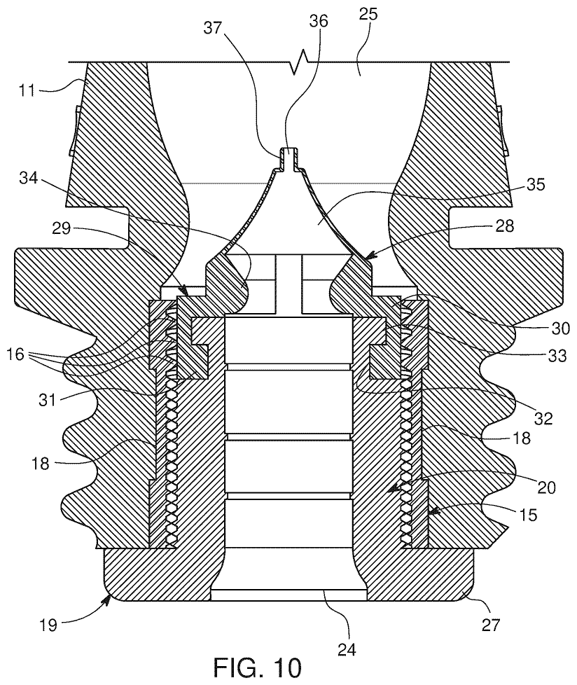

Yet a further form of the valve receiving element 15 is shown in FIG. 10 where only one recess 18 is located intermediate of the ends of the bush 15.

The skilled person will realise that different configurations of projections and/or recesses can be used to achieve anchoring of the bush 15 with the shell 11.

When the bush 15 is over moulded into the shell 11 during the moulding of the shell the bush 15 becomes an integral part of the shell and therefore gluing of the bush into the cavity in the base 14 of the shell 11 will not be required.

However, as described above the cavity in the inlet end of the shell 11 can be formed such that the bush 15 can be fitted into the cavity and glued in place. With such a construction the cavity will, as described, be formed with suitably shaped and positioned projection(s) 17 that can engage in the recess(es) 18 when the bush 15 is pushed into the cavity.

A valve component 19 is fitted into the interior of the bush 15 by preferably a screw fit as hereinafter described. However, the skilled person will appreciate that other mechanical means of securing the valve component 19 in the bush 15 can be used such as a bayonet fit, or an interference fit.

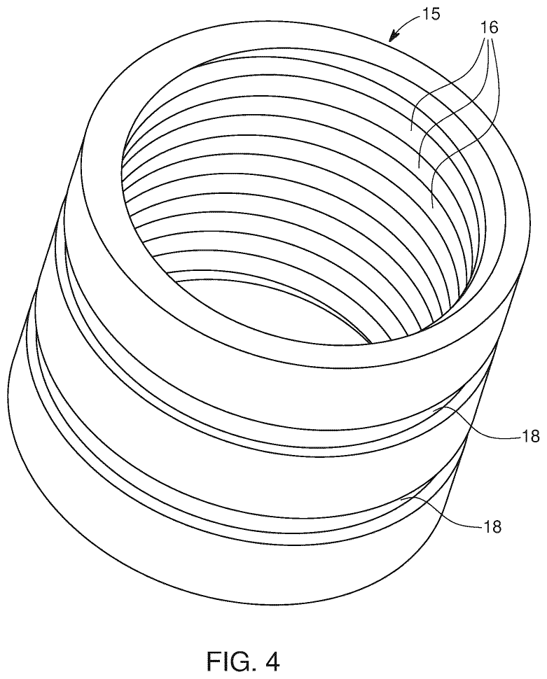

The bush 15 is preferably formed from a hard plastic material (e.g., nylon). As illustrated in, for example, FIGS. 3 and 4, the internal through bore of the bush 15 has a thread form 16.

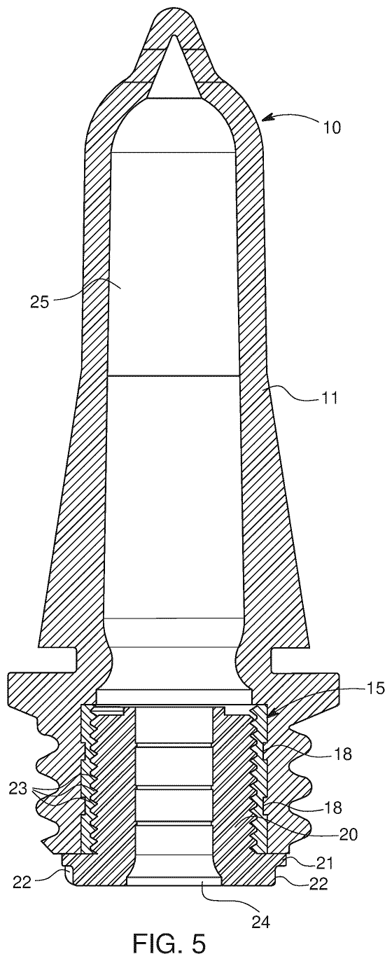

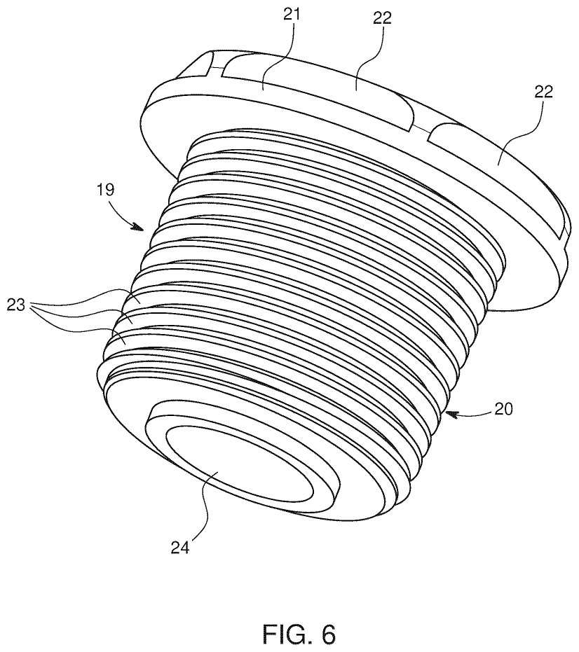

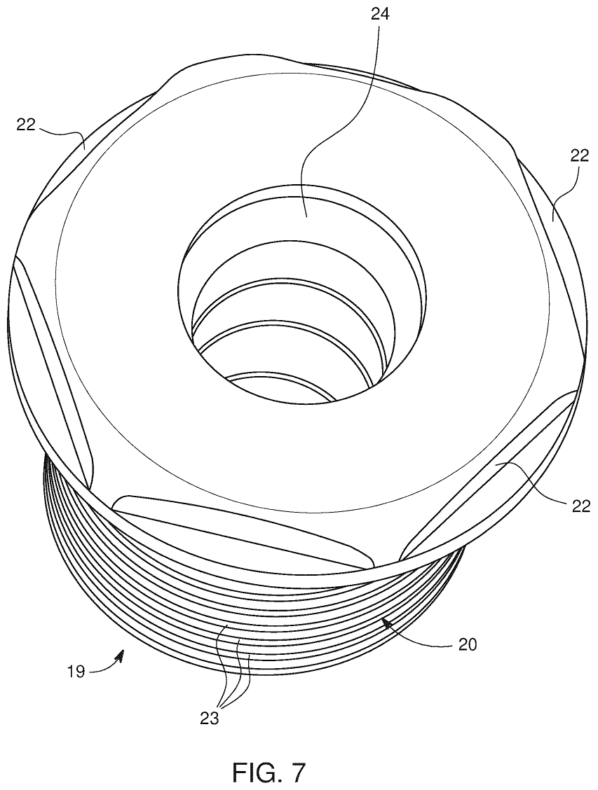

FIGS. 5 to 8 and 10 show that the valve component 19 has an externally threaded body 20. The thread form 23 of the valve body 20 is complementary to thread 16 of the bush 15. A bore 24 extends through the valve body 20.

At or near one end of the body 20 there is a flange 21. The flange 21 preferably includes flats 22 whereby an appropriate spanner type tool (not shown) can be applied to the flats 22 to screw the body 20 into the threaded bore of the bush 15.

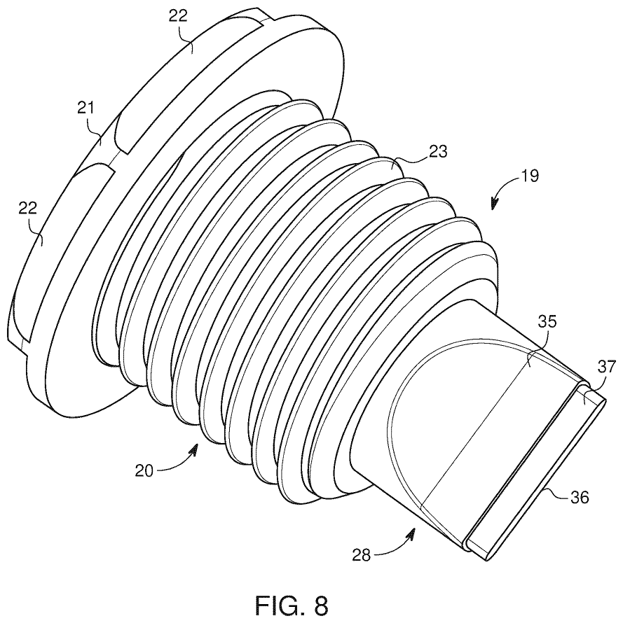

The valve component 19 is completed by operative valve element or elements associated with the bore 24. These can be located (not shown) within the bore 24 of the valve component 19. FIG. 8, however, shows a valve element 28 which projects from the end of the valve body 20 as will hereinafter be described in relation to the embodiment of the invention shown in FIG. 10.

In the preferred method of manufacture of the teat 10 the valve component 19 is threaded into the valve receiving bush 15 once the bush has become retained in the shell 11. However, in another form of the invention the valve component itself could be directly over moulded into the shell 11 during manufacture of the body. With such an arrangement the body 20 of the valve component 19 would preferably include one of more flanges, projections, or recesses. Alternatively, the valve could be installed into the bush 15 and this assembly of parts then over moulded into the shell 11.

When the threaded body 20 of the valve component 19 is installed in the bush 15 the bore 24 of the valve body 20 communicates directly or indirectly (via e.g., a valve element such as valve element 28) with the interior 25 of the shell 11.

In a preferred form the last two inner most of the threads 23 of valve component 19 and 16 of the bush 15 are configured so that they are a tight or interference fit. This prevents the valve component 19, when fully screwed into the bush 15, from becoming disconnected from the bush 15 during normal use of the teat 10. However, if a user of the teat wishes to remove the valve component 19 (e.g., for washing of the valve) this can be achieved by re-engaging the tool with the flats 22 and applying sufficient torque to overcome the interference/tight engagement of these threads to enable the valve component 19 to be unscrewed from the bush 15.

FIG. 10 of the drawings illustrates a further form of the combination of bush 15 and valve component 19. In this form the valve component 19 has the substantially tubular body 20 which is formed from a hard plastics material. Fitted to the end of the body 20 that is distal from the flanged end 27 is a valve element 28. This valve element 28 is formed from a flexible material which, in a preferred form of the invention, is made from silicon.

As shown in FIG. 10 the valve element 28 includes a base portion 29 which includes an annular wall 30 that terminates in an inwardly directed rim 31. The body 20 of the valve component 19 has a shaped end that includes a peripheral recess 32 and a peripherally projecting rim 33. The shape and positioning of the recess 32 and rim 33 are complementary with the base 29, wall 30 and rim 31 (as shown) so that the valve element 28 can be engaged onto the end of the body 20 to form the valve component 19 as shown in FIG. 10.

The valve component 19 shown in FIG. 10 provides the advantage that the body 20 can be made from a hard plastics material (e.g., nylon) for screwing into the hard material bush 15. It also provides the advantage that the operative valve element 28 can be formed from a flexible material. Preferably the flexible material is silicon because it is superior to the polyurethane valves hitherto used in animal feeding teats. It exhibits better wear characteristics and doesn't have the tendency to get hard over time.

The construction is such that only a small clearance exists between the surface of the annular wall 30 and the adjacent thread form 16 of the bush 15. As a consequence the thread 16 will help ensure that the wall 30 and rim 31 remains engaged with the recess 32 and rim 33 to prevent the valve element 28 from becoming detached from the valve body 20.

The operative part of the valve element 28 includes a bulbous portion 34 from which extends a shaped portion 35 formed with a very thin wall section. This shaped portion 35 (which also appears in the valve component 19 shown in FIG. 8) includes an opening 36 which communicates with the interior 25 of the teat body 11. In the preferred construction the opening 36 is in the form of an elongate slot formed by a projecting part 37. The slot 36 is transverse to the longitudinal axis of the bore 24 that extends through the valve body 20.

Because the shaped portion 35 is of very thin cross sectional thickness it is very reactive to any pressure differential between the bore 24 and the interior 26 of the teat body 11. As a result when an animal squeezes on the teat 10 liquid feed in the teat endeavours to flow back through the valve but this causes the slot 36 and the shaped portion 35 to collapse thereby resulting in closure of the valve element. No back flow of liquid through the valve element 28 will thus occur and this maximizes the outflow of liquid feed through the teat outlet 12. When the animal releases pressure on the teat 10 the shaped portion 35 reverts to its normal configuration whereby liquid feed flows through the bore 24 and the slot opening 36 to fill the teat ready for the next squeezing action of the animal feeding on the teat.

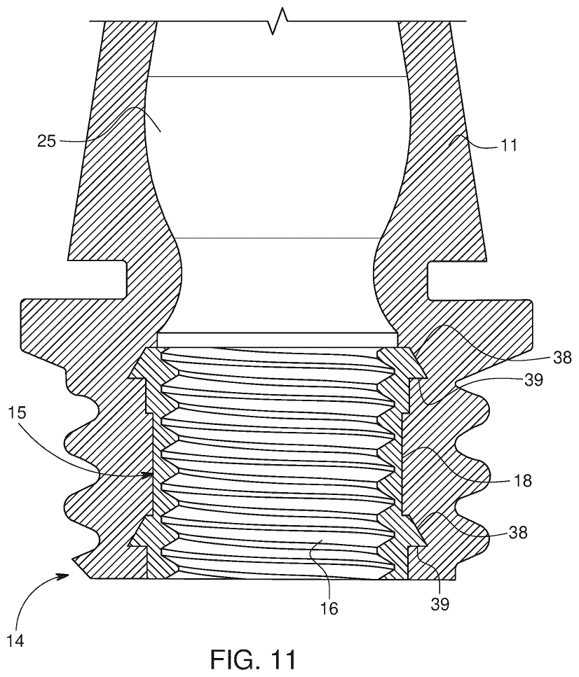

The invention is open to modification (some of which have been described herein) as will be apparent to the skilled person. For example, FIG. 11. illustrates a further form of the valve receiving element 15 installed in the base end 14 of the teat 10. In this form the bush 15 is of the construction shown in FIG. 10 except that in addition to the single recess 18 there are projections 38 which include a surface 39 that is substantially normal to the outer surface of the bush. In the illustrated form the projection 38 is of a substantially right angle triangular cross section. These projections 38 not only provide for better anchorage of the bush in the shell 11 but provide a barrier to prevent leakage if the bush has not been glued in the cavity properly or else if a gap forms due to the shell swelling in the area of the bush 15.

The present invention has been described and illustrated by way of a specific embodiment and method of manufacture, and the embodiment has been described in detail in relation to a particular configuration of teat and method of manufacture. It is not the intention of the Applicant to restrict or in any way limit the scope of the invention to such detail.

Additional advantages and modifications will be readily apparent to those skilled in the art. Therefore, the invention in its broader aspects is not limited to the specific details, representative means of manufacture and method, and illustrative examples shown and described. Accordingly, departures may be made from such details without departure from the spirit or scope of the Applicant's general inventive concept.

1. A teat comprising a moulded hollow body (11) which has an inlet portion (14) and an outlet portion (12) characterized in that a valve receiving element (15) is located with the inlet portion (14).

2. A teat as claimed in claim 1 wherein a valve (19) is installed in the valve receiving element (15).

3. A teat comprising a moulded hollow body (11) that has an inlet end (14) and an outlet end (15) characterized in that a valve receiving element (15) is located with the inlet end (14) of the body (11), the valve receiving element (15) including a bore (24) which opens from the exterior of the body into the interior (25) of the body and a valve (19) installed in the bore.

4. A teat as claimed in claim 3 wherein the valve receiving element (15) is in the form of an annular bush.

5. A teat as claimed in claim 3 wherein the annular bush (15) has one or more projections (17) that engage with the body (11).

6. A teat as claimed in claim 3 wherein the annular bush (15) has one or more recesses (18) into which material from which the body is made can engage.

7. A teat as claimed in claim 3 wherein the annular bush (15) is adhered to the inlet end (14) of the body (11).

8. A teat as claimed in claim 3 wherein the annular bush (15) is mounted in an interference fit with the body (11).

9. A teat as claimed in claim 3 wherein the valve receiving element (15) is over moulded in the inlet end (14) of the body (11).

10. A teat as claimed in claim 1 wherein the body (11) is formed from a resilient material and the valve receiving element (15) is formed from a hard plastics material.

11. A teat as claimed in claim 10 wherein the resilient material is a natural or synthetic rubber.

12. A teat as claimed in claim 1 wherein the valve receiving element (15) is formed with an internal thread (16).

13. A teat as claimed in claim 12 wherein the valve (19) has a complementary thread (23) to that of the bush (15) whereby the threaded part of the valve can be screw fitted into the bush.

14. A teat as claimed in claim 1 wherein the valve (19) includes at least a pair of flats (22) for engagement with a tool to enable the valve to be screwed into the bush (15).

15. A teat as claimed in claim 2 wherein the valve (19) includes a substantially tubular body (20) which is formed from a hard plastics material and fitted to an end of the body is a valve element (28) formed from a flexible material.

16. A teat as claimed in claim 15 wherein the flexible material is silicon.

17. A teat as claimed in claim 16 wherein the valve element (28) includes a base portion (29) which has an annular wall (30) that terminates in an inwardly directed rim (31), the annular wall (30) and rim (31) inter-engaging with a complementary peripheral recess (32) and peripherally projecting rim (33) of the tubular body (20) to thereby complete the valve (19).

18. A teat as claimed in claim 17 wherein the valve element (28) includes a thin walled operative portion (35) that includes an opening (36), the operative portion being configured to be reactive to pressure differentials between the tubular body (20) and the interior (25) of the teat body (11) to cause the opening (36) to open and close.

19. A teat as claimed in claim 18 wherein the opening (36) is a slot opening.

20. A teat comprising a moulded hollow body (11) which has an inlet end (14) and an outlet end (12) characterized in that a valve (19) is over moulded in the inlet end of the body.

21. A teat as claimed in claim 20 wherein the valve (19) is mounted within a valve receiving element (15) and the valve receiving element is over moulded into the body (11).

22. A teat as claimed in claim 21 wherein the valve receiving element (15) includes a bore (24) which communicates with the interior (25) of the body (11) and into which the valve (19) is installed in a screw fit.

23. A method of making an animal feeding teat the method broadly comprising the steps of forming a valve receiving element (15), moulding a teat body (11) and engaging the valve receiving element (15) in an inlet end (14) of the teat body.

24. The method as claimed in claim 23 further including the step of installing a valve (19) in the valve receiving element (15).

25. The method as claimed in claim 23 or wherein during moulding of the body (11) the valve receiving element (15) is over moulded in the part of the body which forms the inlet (14) of the body (11).

26. The method as claimed in claim 23 or wherein the valve receiving element (15) is adhered to the body (11).

27. The method as claimed in claim 24 wherein the valve (19) is screwed into the valve receiving element (15).

28. The method as claimed in claim 25 wherein the valve (19) is adhered in the valve receiving element (15).
